(19) United States
(12) Patent Application Publication
(10) Pub. No.: US 2020/0144852 A1
(43) Pub. Date: May 7, 2020

(54) Charging Bus

(71) Applicant: Christopher Shelton, London (GB)

(72) Inventor: Christopher Shelton, London (GB)

(21) Appl. No.: 16/734,604

(22) Filed: Jan. 6, 2020

Related U.S. Application Data
(63) Continuation-in-part of application No. 15/037,873, filed on May 19, 2016.

(51) Int. Cl. H02J 7/35; H02J 7/00; B63H 21/17

(52) U.S. Cl. CPC H02J 7/35; B63H 2021/171; B63H 21/17; H02J 7/00036

(57) ABSTRACT

An apparatus for the management of one or more power sources when connected to one or more batteries, in particular on a boat, comprises a first power source such as an engine alternator 11 connected to a first source charge manager 26 and a second power source such as a solar panel 13,14 connected to a second source charge manager 26. The first and second source charge managers 26 are connected to a rail 5 maintained over a predetermined range of voltage. The rail 5 is connected to a battery charge manager 33, which manager is connected to a battery such that the battery can be charged from at least one of the first and second power sources.

### CROSS-REFERENCES TO RELATED APPLICATIONS

This non-provisional patent application is a continuation of U.S. patent application Ser. No. 15/037,873. The earlier application listed the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

The invention relates to an apparatus and method for the management of one or more power sources when connected to one or more batteries, in particular in an environment without access to mains electricity such as on a boat.

### 2. Description of the Related Art

Modern small and medium sized boats are provided with a variety of electrical equipment on board such as refrigerators, which are adapted to be powered off an on-board battery. This battery is also sometimes used for starting the on-board engine and will typically be a 12V marinised lead-acid battery. To avoid the risk that the refrigerator and other electrical equipment accidentally drain the battery, it is common to use a second battery for such equipment, often lead-acid but sometimes another type such as a nickel cadmium rechargeable battery. Such batteries ideally need to be completely discharged from time to time in contrast to a lead-acid battery. Small to medium sized boats are also often provided with a number of independent power sources such as a solar cell array in addition to the engine. However, known systems suffer from a number of problems relating to the mismanagement of the power.

The conventional approach in marine technology is simply to use a conventional charger with a three step charging process. In the first step, the charger delivers the maximum current of its capacity to the battery. The duration of this phase depends on the capacity of the battery and charger, respectively and also whether the battery is being used to power any devices such as a refrigerator at the same time. The second step begins once the battery has reached its maximum capacity, which for a lead acid battery is at about 80% of full charge. At this stage the charger current is reduced slowly over a period of several hours, during which time the battery should reach a fully charged state. The final step of this process is the supply of a float voltage to maintain the battery at or near its fully charged state.

Examples of mismanagement include:

1. The use of a solar panel to charge a 12v battery. Such panels usually comprise 36 silicon cells which provide constant current charging at whatever the voltage of the battery—for example 13v. But solar panels are rated at their maximum power point which is commonly a voltage of around 17v. In this instance a 170 W panel would provide 10 A at 17V but would still supply 10 A when connected to a 13v battery and thus deliver only 130 W.

2. An alternator on an engine is generally designed to maintain a starting battery. Such a battery is ideally rarely used and so remains fully charged and ready to start the engine. The alternator is fitted with a regulator so as not to overcharge the battery. In general alternator will charge the battery eventually but will take a long time because as the voltage rises towards the fully charged value, the alternator regulator reduces the current to small amounts. If the battery is used for some other purpose such as lighting, the alternator will behave in the same way and the battery will take some time to reach a fully charged state. A battery is best charged rapidly by delivering current as much as is available. Lead-acid batteries react to this by raising their voltage and so making it hard to deliver the charge. If the source voltage is raised the charge is delivered but care must be taken so as to not over-charge the battery by sensing when the battery charge state is reaching maximum.

3. This problem is compounded when two batteries must be charged from the same source. It is common practice to provide diodes in a mains-powered charger so that several batteries can be charged at the same time. Such diodes prevent the loads from one battery from discharging another but also prevent the batteries from being optimally charged. For example if one battery is fully charged the raised voltage method can be used to get charge in more rapidly than the battery already charged will become over-charged; if the standing voltage method is used the discharged battery will take a long time to charge.

4. It is very difficult to charge batteries with different chemistry simultaneously such as wet lead-acid, gel lead-acid, nickel-cadmium or lithium by connecting them with diodes as each has a different charge regime and voltage.

The present invention seeks to solve the problems encountered when multiple electrical sources are required to charge one or, particularly more, batteries.

### BRIEF SUMMARY OF THE PRESENT INVENTION

According to the invention there is provided an apparatus for the management of one or more power sources when connected to one or more batteries, comprising a first power source connected to a first source charge manager and a second power source connected to a second source charge manager, wherein the first and second source charge managers are connected to a rail, which rail is maintained over a predetermined range of voltage, the rail being connected to a battery charge manager, which manager is connected to a battery such that the battery can be charged from at least one of the first and second power sources.

The invention provides an apparatus and method by which each source can be independently managed and each battery can be independently managed so that each is operated optimally.

The method and apparatus solve these problems by using a separate charge controlling device for each source and a separate device for each battery. These devices are all connected together by a common power connection, the ‘charge rail’, (referred to as Rail), so that power may be delivered to the batteries from the sources. This allows power to the charge rail to be delivered to any battery at any time depending on the batteries' needs and from any source according to its ability to provide power.

### BRIEF DESCRIPTION OF THE SEVERAL VIEWS OF THE DRAWINGS

FIG. 1 shows schematically an arrangement of the charging bus;

FIG. 2 shows schematically an example of a single yacht installation

### DETAILED DESCRIPTION OF THE INVENTION

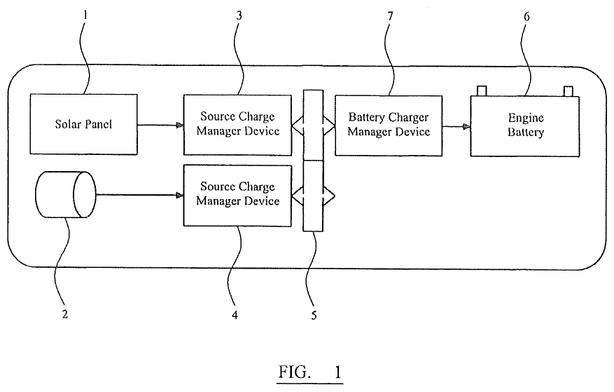

FIG. 1 shows schematically an arrangement of the charging bus. The boat is provided with a first power source, solar panels 1 and a second power source, engine alternator 2. Each of the power sources 1, 2 is connected to a respective manager device 3, 4, which in turn is connected to a charging rail 5. A battery 6 is connected via charging manager 7 to the charging rail 5. The rail voltage can be chosen to be any particular voltage or range of voltage.

The basic method of operation is that sources of a lower voltage than the rail 5 get their power delivered at Rail voltage by a method which increases the voltage by the use of the respective manager device 3,4 such as an active or switching converter and sources with a voltage higher than Rail use a voltage dropping method, preferably lossless, by the respective manager device 3,4 such as a switching converter. Each such converter will be appropriate to the needs of the source as in the following examples:

1. A solar panel is ideally operated at around the maximum voltage it will operate at before the current it supplies is decreased. A nominal 12v panel generally has such a peak power voltage around 17V. The converter to Rail therefore delivers Rail voltage but in such a way that the panel voltage does not drop much below 17V. Such a converter will deliver whatever current the panel can provide at a constant, say, 16V. If there is no demand for the power the panel voltage will increase to whatever the panel design will produce but when power is required the method is to take only that current which will maintain the panel voltage at around 17V. In such a situation the maximum power of the panel is available to the batteries. If no power is needed the panel voltage will rise to its open-circuit value.

2. An alternator such as is found on marine or vehicle engines is typically designed to maintain a starter battery and to provide vehicle power at around 13V. The internal regulator will not usually permit the alternator to deliver high currents unless the voltage drops to that of a discharged battery—say around 12V. By making the alternator always deliver power at Rail Voltage, say 16v, by using an active power supply the alternator voltage can be reduced by the electronics in the power supply so that whatever needed current is delivered even when the engine is operated at low speeds. Also there is no requirement to modify the alternator nor its regulator in any way—the output is simply taken to the special power supply.

In a similar way to management of sources, the management of batteries is done by a dedicated charging manager 7—one to each battery. Such a power supply maintains the Rail voltage by drawing only so much current that the Rail voltage is maintained at a predetermined voltage, say, at around 16V. If current is available from whatever source is generating at the time then that power can be used to charge batteries according to each battery's needs depending on its chemistry (wet or dry lead-acid, nickel-cadmium, nickel-metal-hydride or lithium or nickel-iron). The Rail 6 will supply current at a predetermined Rail voltage to each power unit each of which contains the control regime within it to ideally charge the battery connected to it. Such a regime can take account of the battery's temperature, history as well as the needs of its particular chemistry.

For each battery there is an independent charge controlling power supply so that in a typical application there might be four power units all connected together:

Solar; Alternator; Battery 1; Battery 2

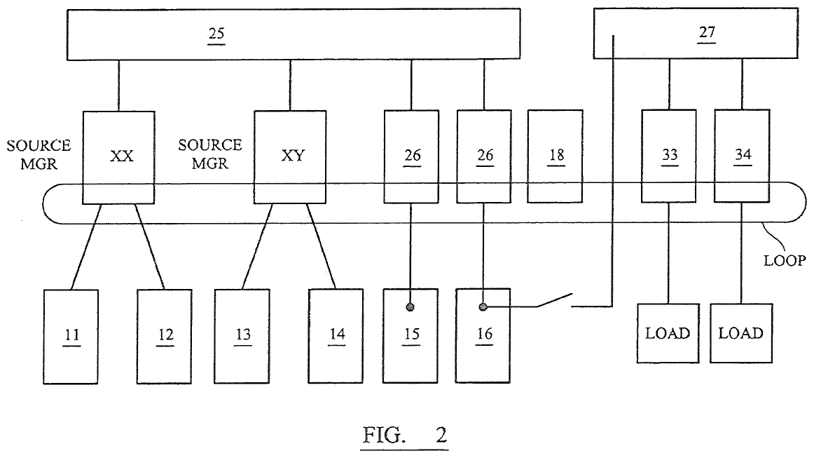

FIG. 2 shows an example of a single yacht installation comprising an engine alternator 11, mains DC supply 12, first and second solar panels 13, 14, an engine battery 15 and a boat battery 16. Each of the aforesaid charging sources is connected to the common charging rail 25 and associated with each charging source type is a respective charge manager 26. A cluster controller 18 is also provided in series with the respective charge managers 26, which enables a connection via USB or Bluetooth to a computer. This provides a networking bridge which enables external controllers to be connected to the system.

The boat battery 16 is also provided with a connection to the load rail 27 which is connected to the load circuits 31 and 32 with associated load controllers 33 and 34. A control loop 35 is provided that connects in series each of the respective charge managers 26, the cluster controller 18 and the load controllers 33 and 34. The load controllers and circuits are also connected to the charging rail or bus 25.

The control loop 35 is, in this example, a polled serial data loop that allows a number of devices such as the charge managers and load controllers to be connected to the cluster controller 18. In use, the cluster controller will poll each of these in an alternate sequence of checking for a fault condition and then collecting parameters and then moving onto the next device on the bus.

The cluster controller 18 uses a short message protocol identifying the device, the input voltage and current and the output current and voltage as well as the temperature of the power source and internal device temperature.

In a further embodiment a source manager 3, 4 delivers a voltage at a slightly higher voltage than nominal Rail voltage; similarly a battery manager 7 might still deliver current when the Rail voltage is lower than nominal rail voltage. In this embodiment the power would be taken preferentially from the high source and delivered preferentially to the lower voltage battery manager. Thus by setting differences in the outputs of source managers 3, 4 and in the levels at which the battery manager(s) 7 regulate the Rail voltage a system of Priority can be enacted.

In addition each unit can communicate to a supervising controller so that not only the source managers 3, 4 and the battery manager(s) 7 can be controlled or adjusted but also the state of charge can be used to communicate to load switches so as further enhance the total system operation by, for example, load-shedding prior to when the batteries were likely to be flat.

An example of a communications method is the use of ferrite ring cores whereby a secondary winding comprising a single wire threaded through the cores and then joined. Thus all the cores were connected in the manner of a current transformer so as to proved isolated serial communications in a simplex manner at low-cost without electrical connection. The method also prevents a failure of any one unit from preventing the operational ones continue to communicate.

An example of intelligent prioritization within the charging system of the present invention may aid the reader's understanding. Accordingly, one exemplary embodiment of this prioritization is described in the following, with reference being made to the installation shown in FIG. 2: The voltage provided on charging rail 25 carries information about what power is available. This information is used by battery charge managers 26 to modulate the demands of the charge managers in order to maintain the rail voltage.

In general, if the voltage on charging rail 25 falls then the batteries mush be supplied with less power (by their respective charge managers) in order to maintain the rail voltage. The output of each source charge manager can be set to a particular voltage in order to convey prioritization information.

The reader will recall that active switching device are preferably used for each source charge manager, so that the output voltage of the source charge manager can be higher than the input voltage of the power source feeding it. In this example, the output voltage of source charge manager XX is set at 18.0v. The output voltage of source charge manager XY is set at 17.8v. In addition to the components shown in FIG. 2, this example includes a wind-powered generator that feeds power through source charge manager XZ onto charging rail 25. The output voltage of source charge manager XZ is set at 17.6v.

The setting of these output voltages provides prioritization. If the engine driving engine alternator 11 is running, then source charge manager XX will be placing 18.0v on charging rail 25. Source managers XY and XZ will not provide any power, since the regulators in XY and XZ will shut down (the voltage on the charging rail being greater than their respective output voltages). The priority implemented is that the engine alternator (or DC mains supply if connected) is given priority when that power is available.

If the engine driving the alternator is stopped when no mains DC 12 is connected, then source charge manager XX will stop providing power to the charging rail. If at this time solar power is being produced by panels 13, 14, then the voltage of charging rail 25 will drop from 18.0v to 17.8v (the output value set for source charge manager XY). The wind-powered generator may be spinning and thereby potentially providing power to source charge manager XZ. However, since the output voltage for source charge manager XZ is only 17.6v, it will not provide any power to the charging rail.

Continuing the example—assume that the sun sets while there is still adequate wind to spin the wind-powered generator. Source charge manager XY will at this point stop feeding power to the charging rail and the charging rail will drop from 17.8v to 17.6v (the output value set for charge manager XZ).

By this means the value of the voltage available on charging rail 25 serves as a source of information about the power available and the voltage is used to control which power source has priority. The voltage on the charging rail at any time (18.0v, 17.8v, or 17.6v in this example) shall be referred to as the “priority voltage.” In this example (which is properly viewed as only one possibility among many) the engine alternator is given first priority as a power source (along with the DC mains), followed by solar power second and wind power third.

In an analogous way, battery charge managers 26 can be controlled by the voltage on charging rail 25. In the example of FIG. 2, the first battery charge manager 26 is connected to a first battery—engine battery 15. The second battery charge manager 26 is connected to a second battery—boat battery 16 (which is connected selectively to load rail 27). A third battery charge manager 26 (not shown in FIG. 2) can be connected to a third battery which is used to power only entertainment systems.

In this example the engine battery 15 is the highest priority, the boat battery 16 is the second priority, and the third battery is the lowest priority. The battery charge manager 26 connected to engine battery 15 can be set to provide charging at any voltage on charging rail 25. The battery charge manager connected to boat battery 16 can be set to provide charging only when the voltage on charging rail 25 (the “priority voltage”) is 17.8v or above. The battery charge manager connected to the third battery can be set to provide charging only when the priority voltage is 18.0v.

A slightly more complex example can be provided. In this more complex example the output voltages for the source charge managers is the same scheme (18.0v, 17.8v, 17.6v). However, the input voltage for the three battery charge managers are set as follows: 17.4v for the battery charge manager connected to the engine battery, 17.2v for the battery charge manager connected to the boat battery, and 17.0v for the battery charge manager connected to the third battery (the one used only for entertainment systems). In this example, the reader will note that any or all of the battery charge managers is able to accept power from any or all of the source charge managers—since the highest input voltage (17.4v) is lower than the lowest potential charging rail voltage (17.6v).

The purpose of priority with respect to the batteries is to be able to assign a particular battery which will have power supplied to it in preference to others when supplies of power are poor. The battery charge managers are preferably active, switched devices as well. Such devices are able to precisely set an input voltage. Each battery charge manager is able to set its output charging power, and therefore its demand on the available power, over a band of input voltages centered on the available priority voltages. For example, a setting of 17.4v would cause the battery charge manager to modulate its output over a 100 mv range so that at 17.45v it would deliver 100% charging output to its attached battery and at 17.35v its output would be zero. By this means the battery connected to this battery charge manager would get power provided that one of the source charge managers is delivering power.

If the engine battery is set to the highest priority then it would charge at the lowest voltage charging rail 25 can drop to. The other battery charge managers would be set at higher voltages so that when input power was limited more and more batteries would drop off line and not be charged.

Of course, when all source power is gone the charging rail voltage cannot be maintained and the system shuts down so that no power to any battery is delivers. If, on the other hand, plenty of power is available then all batteries can be charged at once and each battery charge manager can deliver power to its battery in the way that is best suited to the battery's chemistry and temperature.

It is possible to assign equal priority to two or more source managers. It is also possible to assign equal priority to two or more battery charge managers.

Although the preceding description contains significant detail, it should not be construed as limiting the scope of the invention but rather as providing illustrations of the preferred—embodiments of the invention. Those skilled in the art will be able to devise many other embodiments that carry out the present invention. Thus, the language used in the claims shall define the invention rather than the specific embodiments provided.

Having described my invention, I claim:

1. A system for the management of power sources, which power sources comprise one or more of a solar panel, an alternator or a battery when connected to one or more batteries (6), comprising a first power source (1) connected to a first source charge manager (3), which source charge manager comprises an active or switching converter and a second power source (2) connected to a second source charge manager (4), which second source change manager comprises an active or switching converter wherein the first and second source managers are connected to a rail (5), which rail, in use, is maintained at a predetermined voltage or range of voltages, characterised in that
the rail (5) is connected via battery charge managers (7) comprising a switching converter to a battery (8), the battery charge managers (7) managing the charging of each battery (8) from at least one of the first (1) and second power sources (2) by enacting a system of priority between the first and second power sources.

2. The system for the management of one or more power sources according to claim 1, wherein by setting differences in the output voltages of source managers (3, 4) and of input voltage levels at which the battery manager or managers (7) will operate so as to regulate the rail voltage a system of priority between respective power sources is enacted.

3. The system for the management of one or more power sources according to claim 1, wherein a first battery manager has a higher input voltage setting than a second battery manager, the battery managed by the second battery manager being charged preferentially to the battery managed by the first battery manager in that when the rail voltage drops the higher input one will no longer operate leaving power for the use of the second one.

4. The system for the management of one or more power sources according to claim 1, wherein for sources (1,2) having a lower voltage than the rail the respective source charge manager (3,4) increases the voltage by means of an active or switching converter.

5. The system according to any claim 1, wherein the apparatus is provided with a networking bridge (18) adapted to enable monitoring of the all managers both source and charge managers, the managers being connected by means of a loop (35) adapted to transmit and receive data.
